(19) United States
(12) Patent Application Publication
(10) Pub. No.: US 2025/0265174 A1
(43) Pub. Date: Aug. 21, 2025

(54) Diagnosing Failed Nodes of a Container Orchestration Platform

(71) Applicant: International Business Machines Corporation, Armonk, NY (US)

(72) Inventors: T K Chandra Hasan, Bangalore (IN); Pramod V Gavali, Pune (IN); Abhishek Jain, Baraut (IN)

(21) Appl. No.: 18/444,714

(22) Filed: Feb. 18, 2024

(51) Int. Cl. G06F 11/36; H04L 9/08; H04L 9/32

(52) U.S. Cl. CPC G06F 11/3656; G06F 11/3644; H04L 9/0825; H04L 9/3268

(57) ABSTRACT

Mechanisms are provided for recovering a worker node that is in a not ready state. A first worker node of a cluster is configured with a first debug utility that comprises a debug node agent that monitors an operating state of the first worker node. In response to the debug node agent detecting the first worker node being not ready, the debug node agent sends a request to a debug proxy of a second debug utility associated with a second worker node that is in a ready state, to create a debug worker node for the first worker node based on a customer resource definition from a master node, where the debug worker node has a minimum configuration for handling debug commands. The debug commands from a user are processed via the debug worker node to return the first worker node to a ready state.

### BACKGROUND

The present application relates generally to an improved data processing apparatus and method and more specifically to an improved computing tool and improved computing tool operations/functionality for diagnosing failed nodes in a container orchestration platform, such as a Kubernetes® node in a Kubernetes® container orchestration platform.

Containers are a way to bundle and run applications by specifically placing both the application code and its dependencies into a lightweight, standalone, executable environment. Because everything that is needed for running the application is packaged together into the container, applications can run more quickly and reliability regardless of the computing environment in which they are deployed. Containers have their own filesystem and their own share of processor, memory, process space, and other resources. Because they are not coupled to the underlying infrastructure, they are portable to various execution environments. Containers are generated from container images, which may be defined by the user, or which may be reused from container image repositories. Examples of container technology include the Docker® container mechanisms available from Docker, Inc. and Kubernetes® (also referred to as K8s) available from the Linux Foundation. In Kubernetes®, one or more containers are provided in a basic scheduling unit referred to as a Pod. The containers that run the applications need to be managed in the production environment in order to ensure no downtime. Kubernetes® provides a portable, extensible open source platform for managing containerized workloads and services. For example, if a container goes down, another container needs to start. Kubernetes® provides a framework to run distributed systems resiliently by providing a system that handles scaling and failover of applications, provides deployment patterns, etc.

### SUMMARY

This Summary is provided to introduce a selection of concepts in a simplified form that are further described herein in the Detailed Description. This Summary is not intended to identify key factors or essential features of the claimed subject matter, nor is it intended to be used to limit the scope of the claimed subject matter.

In one illustrative embodiment, a method, in a data processing system, is provided for recovering a worker node that is in a not ready state. The method comprises configuring a first worker node, in a plurality of worker nodes, of a cluster with a first debug utility that comprises a debug node agent that monitors an operating state of the first worker node, and monitoring the operating state of the first worker node to detect whether or not the first worker node enters a not ready state. The method further comprises, in response to the debug node agent detecting that the first worker node enters the not ready state: issuing, by the debug node agent, a request to a debug proxy of a second debug utility associated with a second worker node, in the plurality of worker nodes, that is in a ready state, to create a debug worker node for the first worker node; obtaining, from a master node of the cluster, a custom resource definition (CRD); creating the debug worker node in the cluster based on the CRD, wherein the debug worker node corresponds to the first worker node and comprises a minimum configuration for handling debug commands; and processing debug commands from a user via the debug worker node to return the first worker node to a ready state.

In other illustrative embodiments, a computer program product comprising a computer useable or readable medium having a computer readable program is provided. The computer readable program, when executed on a computing device, causes the computing device to perform various ones of, and combinations of, the operations outlined above with regard to the method illustrative embodiment.

In yet another illustrative embodiment, a system/apparatus is provided. The system/apparatus may comprise one or more processors and a memory coupled to the one or more processors. The memory may comprise instructions which, when executed by the one or more processors, cause the one or more processors to perform various ones of, and combinations of, the operations outlined above with regard to the method illustrative embodiment.

These and other features and advantages of the present invention will be described in, or will become apparent to those of ordinary skill in the art in view of, the following detailed description of the example embodiments of the present invention.

### BRIEF DESCRIPTION OF THE DRAWINGS

The invention, as well as a preferred mode of use and further objectives and advantages thereof, will best be understood by reference to the following detailed description of illustrative embodiments when read in conjunction with the accompanying drawings, wherein:

FIG. 1 is provided as an example of the Kubernetes® container management platform and its components;

FIG. 2 is an example diagram of a distributed data processing system environment in which aspects of the illustrative embodiments may be implemented and at least some of the computer code involved in performing the inventive methods may be executed;

FIG. 3 is an example diagram illustrating the primary operational components of a debug kubelet utility in accordance with one illustrative embodiment;

FIGS. 4A and 4B are example diagrams illustrating a worker node entering a critical/not ready state;

FIG. 5 is an example diagram illustrating the view of the additional node of the debug node agent, such as a debug kubelet, in accordance with one illustrative embodiment;

FIGS. 6A and 6B illustrate an example sequence diagram outlining how a Certificate Signing Request (CSR) and Pod create request are processed when a debug-kubelet is spawned in accordance with one illustrative embodiment;

FIG. 7A is a flowchart outlining an example operation of a debug node agent, such as a debug kubelet, in accordance with one illustrative embodiment; and

FIG. 7B is a flowchart outlining an operation of a debug pod in accordance with one illustrative embodiment.

### DETAILED DESCRIPTION

The illustrative embodiments provide an improved computing tool and improved computing tool operations/functionality for diagnosing failed nodes in a container orchestration platform, such as Kubernetes® nodes in a Kubernetes® container orchestration platform. The illustrative embodiments will be described herein with reference to a Kubernetes® container orchestration or management platform and thus, will make reference to components of that specific container management platform using the terminology specific to Kubernetes®. As such, it will be assumed that one of ordinary skill in the art is familiar with the Kubernetes® container orchestration or management platform and its components and operations. However, it should be appreciated that the mechanisms of the illustrative embodiments may also be adapted to other container orchestration or management platforms that utilize similar components and platforms, regardless of the particular terminology used. In such cases, it is again assumed that those of ordinary skill in the art are familiar with such other container orchestration or management platforms and their components and operations.

To better understand the technological improvements provided by the mechanisms of the illustrative embodiments, it is good to first have a general understanding of an example container orchestration/management platform, such as a Kubernetes® container orchestration/management platform, hereafter referred to as a container management platform. This overview of the example Kubernetes® container management platform is to provide an example context for the subsequent description of an example illustrative embodiment and is not intended to be limiting of the illustrative embodiments.

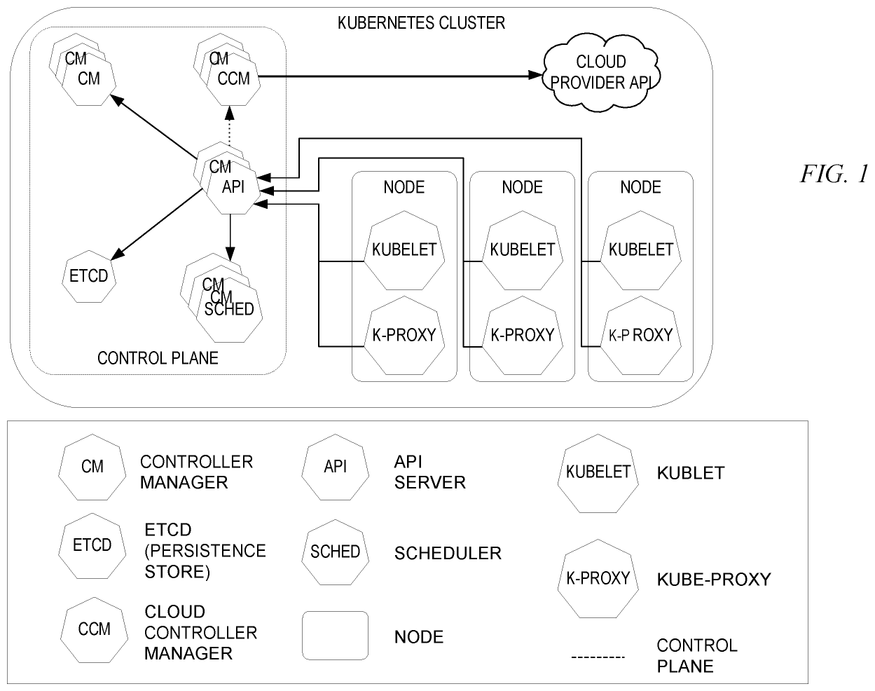

FIG. 1 is provided as an example of the Kubernetes® container management platform and its components. As shown in FIG. 1, the container management platform 100, when Kubernetes® is deployed to a computing infrastructure, one obtains a Kubernetes® cluster. The cluster comprises a set of worker machines, called nodes, that run containerized applications. Every cluster has at least one worker node, with each worker node hosting the Pods. The Pods are the components of the application workload, with each Pod having one or more containers. The control plane manages the worker nodes and the Pods in the cluster. In production environments, the control plane may run across multiple computers and a cluster may run multiple nodes, providing fault-tolerance and high availability.

The control plane components make global decisions about the cluster, e.g., scheduling decisions, as well as detect and respond to cluster events, e.g., starting up a new Pod when a Deployment's replicas field is unsatisfied. Control plane components can be run on any machine in the cluster. However, for simplicity, set up scripts may start control plane components on the same machine, and do not run user containers on this machine.

The API server is a front end component of the control plane that exposes the Kubernetes® API. The Kubernetes® API is a REST API that allows for communication between end users, different parts of the cluster, and external components. The Kubernetes® API provides functionality to query and manipulate the state of API objects in Kubernetes, e.g., Pods, namespaces, configuration maps, events, and the like. The main implementation of the API server is kube-apiserver which is designed to scale horizontally. That is, kube-apiserver scales by deploying more instances. Several instances of kube-apiserver may be run and traffic balanced between those instances. Etcd provides a consistent and highly-available key value store used as a backing store for all cluster data.

Kube-scheduler is a control plane component that watches for newly created Pods with no assigned node, and selects a node for them to run on. Factors taken into account for scheduling decisions include individual and collective resource requirements, hardware/software/policy constraints, affinity and anti-affinity specifications, data locality, inter-workload interference, and deadlines.

The kube-Controller-manager is a control plane component that runs Controller processes. The Controller processes are control loops that watch the state of a cluster and makes or requests changes to the state where needed. Each Controller tires to move the current cluster state closer to a desired state. To understand Controllers, consider a non-terminating loop that regulates the state of a system, such as a thermostat in a room, as an example. When the temperature is set on the thermostat, the setting tells the thermostat the desired state. The actual measured temperature in the room is the current state, and the thermostat's operation is intended to control the heating/air conditioning to bring the current state closer to the desired state.

The Controllers in Kubernetes® track the state of at least one Kubernetes® resource object. These objects have a specific field that designate the desired state. The Controllers may carry out actions themselves to bring the current state closer to the desired state, or may communicate with other components through the Kubernetes® API and API server to have the other components perform actions to adjust the state.

As an example, a Job Controller is an example of a Kubernetes® built-in Controller (a Controller that manages state by interacting with the cluster API server). The “Job” is a Kubernetes® resource that runs one or more Pods in order to perform a task. When the Job Controller sees a new task it makes sure that, somewhere in the cluster, the kubelets (node agent running on a node) on a set of Nodes are running the right number of Pods to get the work done. The Job Controller does not run any Pods or containers itself but, instead, tells the API server to create or remove Pods. Other components in the control plane act on the new information, such as by scheduling and running additional Pods, until the task is completed. After a new Job resource is created, the desired state is for that Job resource is for it to be completed. The Job Controller makes the current state for that Job be nearer to the desired state (completed) by controlling the creation of Pods that perform the work for that Job. Controllers also update the objects that configure them. For example: once the work is done for a Job, the Job Controller updates that Job object (resource) to mark it as “finished.”

In contrast with the Job Controller, some Controllers need to make changes to things outside of the cluster. For example, if one uses a control loop to make sure there are enough nodes in the cluster, then that Controller needs something outside the current cluster to set up new nodes when needed. Controllers that interact with external state find their desired state from the API server, and then communicate directly with an external system to bring the current state closer to the desired state.

Thus, the Controllers operate to make changes to bring about a desired state, and then reports the current state back to the cluster's API server. Other Controllers can observe that reported data and take their own actions accordingly. Kubernetes® takes a cloud-native view of systems, and is able to handle constant change, since clusters may change state at any point as work is performed. Controllers, or control loops, automatically monitor and adjust to state changes and operate to address failures.

Kubernetes® uses a plethora of Controllers that each manage a particular aspect of cluster state. Most commonly, a particular Controller will use one type of resource as its desired state, and has a different type of resource that it manages to make that desired state happen. For example, a Controller for Jobs tracks Job objects (resources) and Pod objects (to run the Jobs, and then to see when the work is finished). In this case something else creates the Jobs, whereas the Job Controller creates Pods. There can be more than one Controller that creates or updates the same type of object, the Controllers operating only with regard to the resources linked to their controlling resource. For example, one can have Deployments and Jobs which both create Pods, but the Job Controller does not delete Pods that the deployment created because there is information (labels) the Controllers use to tell those Pods apart from one another. A Kubernetes® Deployment is a resource object that provides declarative updates to applications and describes an applications' life cycle, such as which images to use for the application, the number of Pods there should be, and the way in which those Pods should be updated.

Kubernetes® comes with a set of built-in Controllers that run inside the kube-Controller-manager. These built-in Controllers provide important core behaviors. The deployment Controller and Job Controller are examples of Controllers that come as part of Kubernetes® itself, and thus are referred to as “built-in” Controllers. Additional Controllers may be obtained that run outside the control plane to extend the Kubernetes® platform. In addition, users can create their own Controllers which may be run as a set of Pods.

To reduce complexity, Controllers are compiled into a single binary and run in a single process. There are many different types of Controllers including a node Controller, Job Controller, EndpointSlice Controller, ServiceAccount Controller, route Controller, service Controller, and the like. The node Controller is responsible for noticing and responding when nodes go down. The Job Controller watches for Job objects that represent one-off tasks, then creates Pods to run those tasks to completion. The EndpointSlice Controller populates EndpointSlice objects (to provide a link between Services and Pods). The ServiceAccount Controller creates default ServiceAccounts for new namespaces. The route Controller operates to set up routes in the underlying cloud infrastructure. The service Controller operates to create, update, and delete cloud provider load balancers. The node Controller, route Controller, and service Controller may all have cloud provider dependencies. These are only examples of Controllers and is not exhaustive of the Controllers that may be employed in the control plane of the container management platform 100.

The cloud Controller manager is a control plane component that embeds cloud-specific control logic that operates to link a cluster into a cloud provider's API, and separates out the components that interact with that cloud platform from components that only interact with the cluster. The cloud-Controller-manager only runs Controllers that are specific to the cloud provider. If the cluster is being executed in a non-cloud infrastructure, the cluster does not have a cloud Controller manager. As with the kube-Controller-manager, the cloud-Controller-manager combines several logically independent control loops into a single binary that can be run as a single process.

Node components run on every node, maintaining running Pods and providing the Kubernetes® runtime environment. In the node, a kubelet is executed that operates as an agent process that makes sure that containers are running in a Pod. The kubelet takes a set of PodSpecs that are provided through various mechanisms and ensures that the containers described in those PodSpecs are running and healthy.

Kube-proxy is a node component that operates as a network proxy running on each node in the cluster and implements part of the Kubernetes® Service. The kube-proxy maintains network rules on nodes which allow network communication to the Pods from network sessions inside or outside of the cluster. Kube-proxy uses the operating system packet filtering layer if there is one available, otherwise it forwards the traffic itself.

The container runtime is a fundamental component of the node that is responsible for managing the execution and lifecycle of containers within the Kubernetes® environment. Kubernetes® supports container runtimes such as containerd, container runtime interface (CRI)-O, and any other implementations of the Kubernetes® CRI.

A Kubernetes® Operator, or simply “Operator” as used herein, is a custom Kubernetes® Controller that uses custom resources (CR) to manage applications and their components. The Operators are tailored to specific applications, follow the control loop principles of Controllers, and extend a clusters behavior by linking Controllers to one or more CRs without modifying the code of Kubernetes® itself. are designed to transition the cluster into the desired state of the application. Operators operate to automate processes, such as processes directed to repeated behaviors. Examples of processes that may be automated by Operators include, but are not limited to: deploying an application on demand, taking and restoring backups of the application state, handling upgrades of the application code alongside related changes such as database schemas or extra configuration settings, publishing a Service to applications that do not support Kubernetes® APIs to discover them, simulating failure in all or part of the cluster to test cluster resilience, choosing a leader for a distributed application without an internal member election process.

As an example, an Operator may have a custom resource named CustomDB, that can be configured into the cluster, a deployment that makes sure a Pod is running that contains the Controller part of the Operator, a container image of the Operator code, and Controller code that queries the control plane to find out what CustomDB resources are configured.

The core of the Operator is code to tell the API server how to make reality match the configured resources. For example, if a new CustomDB is added, the Operator sets up Persistent VolumeClaims to provide durable database storage, a StatefulSet to run CustomDB and a Job object to handle initial configuration. If the CustomDB is deleted, the Operator takes a snapshot and then makes sure that the StatefulSet and Volumes are also removed. The Operator also manages regular database backups. For each CustomDB resource, the Operator determines when to create a Pod that can connect to the database and make backups. These Pods rely on a configuration mapping (ConfigMap) and/or a Secret (an object that contains a small amount of sensitive data) that has database connection details and credentials.

Because the Operator aims to provide robust automation for the resource it manages, there may be additional supporting code. For example, using the CustomDB example above, supporting code may be provided that checks to see if the database is running an old version and, if so, creates Job objects that upgrade it to the current version.

The most common way to deploy an Operator is to add the Custom Resource Definition (CRD) and its associated Controller to a cluster. The Controller will normally run outside of the control plane. For example, the Controller can be run in a cluster as a deployment. Once the Operator is deployed, it can be used by adding, modifying or deleting the type of resource that the Operator uses.

Each Operator may manage multiple Controllers. As such, the atomicity of another Controller may be broken if one of the Operator Controllers break the Operator process, since all of the Controllers are part of the same Operator process. As a result, the deployed Custom Resource may be in an unrecognized state. For example, consider a Controller that creates two configmaps at the end, one which includes the Custom Resource version, and the other includes the Custom Resource deployment result. The Controller assumes that the two configmaps are created together and both should exist. Each time the Controller begins, it reads the Custom Resource version and deploy result from the two configmaps. However, if the Operator is broken right after one configmap is created, then only one configmap exists. The Controller, as a result, will fail.

The Operator may fail to reconcile even if the Operator Pod is recovered because the atomicity of the Operator process is broken. Moreover, it is difficult to determine the root cause of the failure. That is, using the example above, one can see that the Controller has failed and at which step the failure occurred. However, it cannot be known why there is only one configmap and why the other configmap was not created. The configmap should have been created but the Operator crash, or breaking of the Operator, terminated the creation.

With the above general understanding of an example container management platform, it can be appreciated that cloud provider companies that offer the Kubernetes® Cluster as a service, such as IBM, Amazon Web Services (AWS), Microsoft Azure, or the like, strive to provide highly available and stable clusters to their customers. The most critical and frequent problem of a Kubernetes® Cluster as a service is when a worker node goes into a critical/not ready state that impacts the overall business commitments. When a worker node goes into such a critical/not ready state, both the cloud provider and the customer have to work together to bring the failed or broken worker node, i.e., the worker node that is in a critical/not ready state, back to a ready state. However, there are cases where the cloud provider Site Reliability Engineering (SRE) engineer does not have permission to directly access the Kubernetes® cluster's nodes, while on the other side, the customer is not able to gain access to the underlying platform infrastructure to bring the worker node back to the ready state. In such a case, both parties need a method to diagnose the failed or broken node that is in the critical/not ready state as quickly as possible.

Most cloud providers disable root access by the customer computing system to the Kubernetes® worker node immediately after the customer computing system joins the Kubernetes® cluster. Now when the worker node enters a critical/not ready, it is difficult to connect that worker node and obtain diagnostic information as the Site Reliability Engineering (SRE) engineer cannot access the cluster nodes and the customer computing system cannot access the underlying infrastructure. As part of this debugging process, one needs to connect to the cloud service provider, but there is too much back and forth, i.e., multiple rounds of discussions between the customer and the cloud provider such as via electronic mail or a support ticket system, to resolve the broken node.

The illustrative embodiments provide an improved computing tool and improved computing tool operations/functionality to detect the failed (or “broken”) worker node, e.g., the failed/broken Kubernetes® node in the cluster. The illustrative embodiments operate to improve the SRE efficiency by reducing the multiple communications among SREs, cloud engineer, and customers during a critical issue such as a worker node entering a critical/not ready state. The illustrative embodiments provide an intelligent and secure mechanism to deploy the debug utilities, such as debug-kubelet and debug pod, which can bypass the dependency on the other failed/running components and assist authorized users, e.g., an administrators of the customer and/or cloud provider, to run a command to recover the critical worker node under the cloud vendor SRE automated guidance.

One example component of the illustrative embodiments is the debug-kubelet which is a lightweight kubelet configured to debug critical/not ready worker nodes by reducing the multiple failure points in the standard kubelet flow. The debug-kubelet relies on container runtime (crun/runc) with debug taints being set at the time of worker registration. The debug-kubelet and debug taints avoid regular workloads from being scheduled and deploys only one privileged debug-pod, e.g., the debug taints only allow the debug-kubelet to execute the privileged debug-pod. As the debug-kubelet does not have any image server, it locally creates a root file system (rootfs) bundle with bare minimum binaries copied from the failed/broken worker node to create containers using the container runtime (crun/runc). This allows a user to effectively create a debug container in the worker, as a backup or debug worker node, without relying on any container image from external container image registries.

Thus, the illustrative embodiments provide a capability through which a user can access the failed system/node temporarily, such as over a HTTPS channel or the like. The user can fix the problem on his/her own or they can provide more information/logs about the failed system/node to the cloud provider. In this way, the “back and forth” mentioned above, which causes significant delay in solving the problem of a failed system/node, are minimized.

Before continuing the discussion of the various aspects of the illustrative embodiments and the improved computer operations performed by the illustrative embodiments, it should first be appreciated that throughout this description the term “mechanism” will be used to refer to elements of the present invention that perform various operations, functions, and the like. A “mechanism,” as the term is used herein, may be an implementation of the functions or aspects of the illustrative embodiments in the form of an apparatus, a procedure, or a computer program product. In the case of a procedure, the procedure is implemented by one or more devices, apparatus, computers, data processing systems, or the like. In the case of a computer program product, the logic represented by computer code or instructions embodied in or on the computer program product is executed by one or more hardware devices in order to implement the functionality or perform the operations associated with the specific “mechanism.” Thus, the mechanisms described herein may be implemented as specialized hardware, software executing on hardware to thereby configure the hardware to implement the specialized functionality of the present invention which the hardware would not otherwise be able to perform, software instructions stored on a medium such that the instructions are readily executable by hardware to thereby specifically configure the hardware to perform the recited functionality and specific computer operations described herein, a procedure or method for executing the functions, or a combination of any of the above.

The present description and claims may make use of the terms “a”, “at least one of”, and “one or more of” with regard to particular features and elements of the illustrative embodiments. It should be appreciated that these terms and phrases are intended to state that there is at least one of the particular feature or element present in the particular illustrative embodiment, but that more than one can also be present. That is, these terms/phrases are not intended to limit the description or claims to a single feature/element being present or require that a plurality of such features/elements be present. To the contrary, these terms/phrases only require at least a single feature/element with the possibility of a plurality of such features/elements being within the scope of the description and claims.

Moreover, it should be appreciated that the use of the term “engine,” if used herein with regard to describing embodiments and features of the invention, is not intended to be limiting of any particular technological implementation for accomplishing and/or performing the actions, steps, processes, etc., attributable to and/or performed by the engine, but is limited in that the “engine” is implemented in computer technology and its actions, steps, processes, etc. are not performed as mental processes or performed through manual effort, even if the engine may work in conjunction with manual input or may provide output intended for manual or mental consumption. The engine is implemented as one or more of software executing on hardware, dedicated hardware, and/or firmware, or any combination thereof, that is specifically configured to perform the specified functions. The hardware may include, but is not limited to, use of a processor in combination with appropriate software loaded or stored in a machine readable memory and executed by the processor to thereby specifically configure the processor for a specialized purpose that comprises one or more of the functions of one or more embodiments of the present invention. Further, any name associated with a particular engine is, unless otherwise specified, for purposes of convenience of reference and not intended to be limiting to a specific implementation. Additionally, any functionality attributed to an engine may be equally performed by multiple engines, incorporated into and/or combined with the functionality of another engine of the same or different type, or distributed across one or more engines of various configurations.

In addition, it should be appreciated that the following description uses a plurality of various examples for various elements of the illustrative embodiments to further illustrate example implementations of the illustrative embodiments and to aid in the understanding of the mechanisms of the illustrative embodiments. These examples intended to be non-limiting and are not exhaustive of the various possibilities for implementing the mechanisms of the illustrative embodiments. It will be apparent to those of ordinary skill in the art in view of the present description that there are many other alternative implementations for these various elements that may be utilized in addition to, or in replacement of, the examples provided herein without departing from the spirit and scope of the present invention.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

It should be appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable sub-combination.

The present invention may be a specifically configured computing system, configured with hardware and/or software that is itself specifically configured to implement the particular mechanisms and functionality described herein, a method implemented by the specifically configured computing system, and/or a computer program product comprising software logic that is loaded into a computing system to specifically configure the computing system to implement the mechanisms and functionality described herein. Whether recited as a system, method, of computer program product, it should be appreciated that the illustrative embodiments described herein are specifically directed to an improved computing tool and the methodology implemented by this improved computing tool. In particular, the improved computing tool of the illustrative embodiments specifically provides a debug kubelet utility having a debug operator, debug proxy, and debug kubelet. The improved computing tool implements mechanism and functionality, such as debug kubelet utility functionality for establishing a connection with a backup worker node such that an administrator may recover the worker node into a ready state, which cannot be practically performed by human beings either outside of, or with the assistance of, a technical environment, such as a mental process or the like. The improved computing tool provides a practical application of the methodology at least in that the improved computing tool is able to diagnose and return failed or broken worker nodes in a container orchestration/management platform to a ready state.

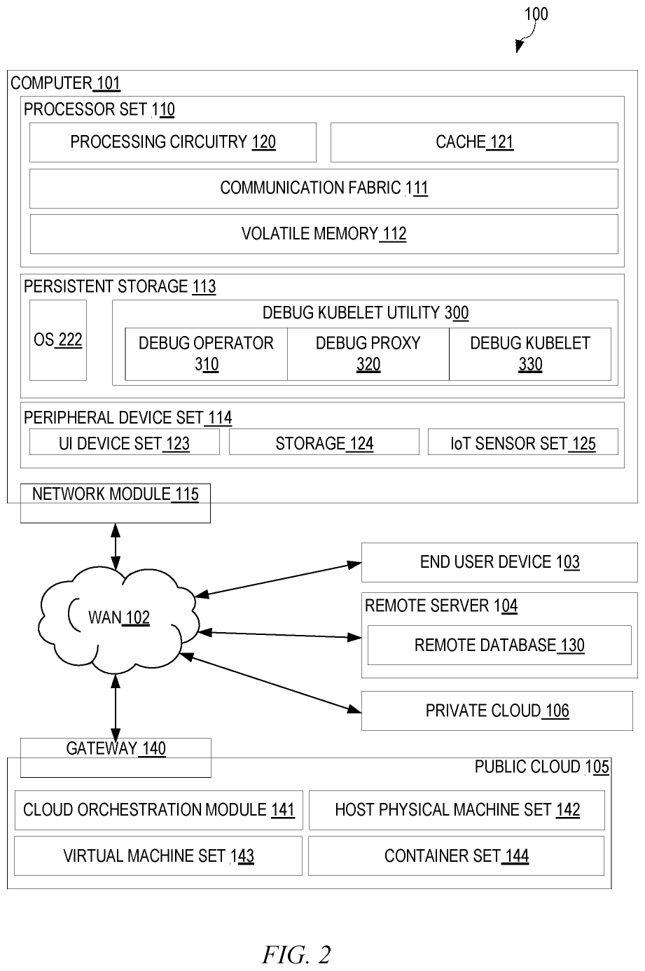

FIG. 2 is an example diagram of a distributed data processing system environment in which aspects of the illustrative embodiments may be implemented and at least some of the computer code involved in performing the inventive methods may be executed. That is, computing environment 200 contains an example of an environment for the execution of at least some of the computer code involved in performing the inventive methods, such as a debug kubelet utility 300 having a debug operator 310, debug proxy 320, and debug kubelet 330. In addition to debug kubelet utility 300, computing environment 200 includes, for example, computer 201, wide area network (WAN) 202, end user device (EUD) 203, remote server 204, public cloud 205, and private cloud 206. In this embodiment, computer 201 includes processor set 210 (including processing circuitry 220 and cache 221), communication fabric 211, volatile memory 212, persistent storage 213 (including operating system 222 and debug kubelet utility 300, as identified above), peripheral device set 214 (including user interface (UI), device set 223, storage 224, and Internet of Things (IoT) sensor set 225), and network module 215. Remote server 204 includes remote database 230. Public cloud 205 includes gateway 240, cloud orchestration module 241, host physical machine set 242, virtual machine set 243, and container set 244.

Computer 201 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 230. As is well understood in the art of computer technology, and depending upon the technology, performance of a computer-implemented method may be distributed among multiple computers and/or between multiple locations. On the other hand, in this presentation of computing environment 200, detailed discussion is focused on a single computer, specifically computer 201, to keep the presentation as simple as possible. Computer 201 may be located in a cloud, even though it is not shown in a cloud in FIG. 2. On the other hand, computer 201 is not required to be in a cloud except to any extent as may be affirmatively indicated.

Processor set 210 includes one, or more, computer processors of any type now known or to be developed in the future. Processing circuitry 220 may be distributed over multiple packages, for example, multiple, coordinated integrated circuit chips. Processing circuitry 220 may implement multiple processor threads and/or multiple processor cores. Cache 221 is memory that is located in the processor chip package(s) and is typically used for data or code that should be available for rapid access by the threads or cores running on processor set 210. Cache memories are typically organized into multiple levels depending upon relative proximity to the processing circuitry. Alternatively, some, or all, of the cache for the processor set may be located “off chip.” In some computing environments, processor set 210 may be designed for working with qubits and performing quantum computing.

Computer readable program instructions are typically loaded onto computer 201 to cause a series of operational steps to be performed by processor set 210 of computer 201 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 221 and the other storage media discussed below. The program instructions, and associated data, are accessed by processor set 210 to control and direct performance of the inventive methods. In computing environment 200, at least some of the instructions for performing the inventive methods may be stored in debug kubelet utility 300 in persistent storage 213.

Communication fabric 211 is the signal conduction paths that allow the various components of computer 201 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 212 is any type of volatile memory now known or to be developed in the future. Examples include dynamic type random access memory (RAM) or static type RAM. Typically, the volatile memory is characterized by random access, but this is not required unless affirmatively indicated. In computer 201, the volatile memory 212 is located in a single package and is internal to computer 201, but, alternatively or additionally, the volatile memory may be distributed over multiple packages and/or located externally with respect to computer 201.

Persistent storage 213 is any form of non-volatile storage for computers that is now known or to be developed in the future. The non-volatility of this storage means that the stored data is maintained regardless of whether power is being supplied to computer 201 and/or directly to persistent storage 213. Persistent storage 213 may be a read only memory (ROM), but typically at least a portion of the persistent storage allows writing of data, deletion of data and re-writing of data. Some familiar forms of persistent storage include magnetic disks and solid state storage devices. Operating system 222 may take several forms, such as various known proprietary operating systems or open source Portable Operating System Interface type operating systems that employ a kernel. The code included in debug kubelet utility 300 typically includes at least some of the computer code involved in performing the inventive methods.

Peripheral device set 214 includes the set of peripheral devices of computer 201. Data communication connections between the peripheral devices and the other components of computer 201 may be implemented in various ways, such as Bluetooth connections, Near-Field Communication (NFC) connections, connections made by cables (such as universal serial bus (USB) type cables), insertion type connections (for example, secure digital (SD) card), connections made through local area communication networks and even connections made through wide area networks such as the internet. In various embodiments, UI device set 223 may include components such as a display screen, speaker, microphone, wearable devices (such as goggles and smart watches), keyboard, mouse, printer, touchpad, game controllers, and haptic devices. Storage 224 is external storage, such as an external hard drive, or insertable storage, such as an SD card. Storage 224 may be persistent and/or volatile. In some embodiments, storage 224 may take the form of a quantum computing storage device for storing data in the form of qubits. In embodiments where computer 201 is required to have a large amount of storage (for example, where computer 201 locally stores and manages a large database) then this storage may be provided by peripheral storage devices designed for storing very large amounts of data, such as a storage area network (SAN) that is shared by multiple, geographically distributed computers. IoT sensor set 225 is made up of sensors that can be used in Internet of Things applications. For example, one sensor may be a thermometer and another sensor may be a motion detector.

Network module 215 is the collection of computer software, hardware, and firmware that allows computer 201 to communicate with other computers through WAN 202. Network module 215 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 215 are performed on the same physical hardware device. In other embodiments (for example, embodiments that utilize software-defined networking (SDN)), the control functions and the forwarding functions of network module 215 are performed on physically separate devices, such that the control functions manage several different network hardware devices. Computer readable program instructions for performing the inventive methods can typically be downloaded to computer 201 from an external computer or external storage device through a network adapter card or network interface included in network module 215.

WAN 202 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 203 is any computer system that is used and controlled by an end user (for example, a customer of an enterprise that operates computer 201), and may take any of the forms discussed above in connection with computer 201. EUD 203 typically receives helpful and useful data from the operations of computer 201. For example, in a hypothetical case where computer 201 is designed to provide a recommendation to an end user, this recommendation would typically be communicated from network module 215 of computer 201 through WAN 202 to EUD 203. In this way, EUD 203 can display, or otherwise present, the recommendation to an end user. In some embodiments, EUD 203 may be a client device, such as thin client, heavy client, mainframe computer, desktop computer and so on.

Remote server 204 is any computer system that serves at least some data and/or functionality to computer 201. Remote server 204 may be controlled and used by the same entity that operates computer 201. Remote server 204 represents the machine(s) that collect and store helpful and useful data for use by other computers, such as computer 201. For example, in a hypothetical case where computer 201 is designed and programmed to provide a recommendation based on historical data, then this historical data may be provided to computer 201 from remote database 230 of remote server 204.

Public cloud 205 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 205 is performed by the computer hardware and/or software of cloud orchestration module 241. The computing resources provided by public cloud 205 are typically implemented by virtual computing environments that run on various computers making up the computers of host physical machine set 242, which is the universe of physical computers in and/or available to public cloud 205. The virtual computing environments (VCEs) typically take the form of virtual machines from virtual machine set 243 and/or containers from container set 244. It is understood that these VCEs may be stored as images and may be transferred among and between the various physical machine hosts, either as images or after instantiation of the VCE. Cloud orchestration module 241 manages the transfer and storage of images, deploys new instantiations of VCEs and manages active instantiations of VCE deployments. Gateway 240 is the collection of computer software, hardware, and firmware that allows public cloud 205 to communicate through WAN 202.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 206 is similar to public cloud 205, except that the computing resources are only available for use by a single enterprise. While private cloud 206 is depicted as being in communication with WAN 202, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 205 and private cloud 206 are both part of a larger hybrid cloud.

As shown in FIG. 2, one or more of the computing devices, e.g., computer 201 or remote server 204, may be specifically configured to implement a debug-kubelet utility. The configuring of the computing device may comprise the providing of application specific hardware, firmware, or the like to facilitate the performance of the operations and generation of the outputs described herein with regard to the illustrative embodiments. The configuring of the computing device may also, or alternatively, comprise the providing of software applications stored in one or more storage devices and loaded into memory of a computing device, such as computer 201 or remote server 204, for causing one or more hardware processors of the computing device to execute the software applications that configure the processors to perform the operations and generate the outputs described herein with regard to the illustrative embodiments. Moreover, any combination of application specific hardware, firmware, software applications executed on hardware, or the like, may be used without departing from the spirit and scope of the illustrative embodiments.

It should be appreciated that once the computing device is configured in one of these ways, the computing device becomes a specialized computing device specifically configured to implement the mechanisms of the illustrative embodiments and is not a general purpose computing device. Moreover, as described hereafter, the implementation of the mechanisms of the illustrative embodiments improves the functionality of the computing device and provides a useful and concrete result that facilitates debugging of failed worker nodes by way of a debug-kubelet utility.

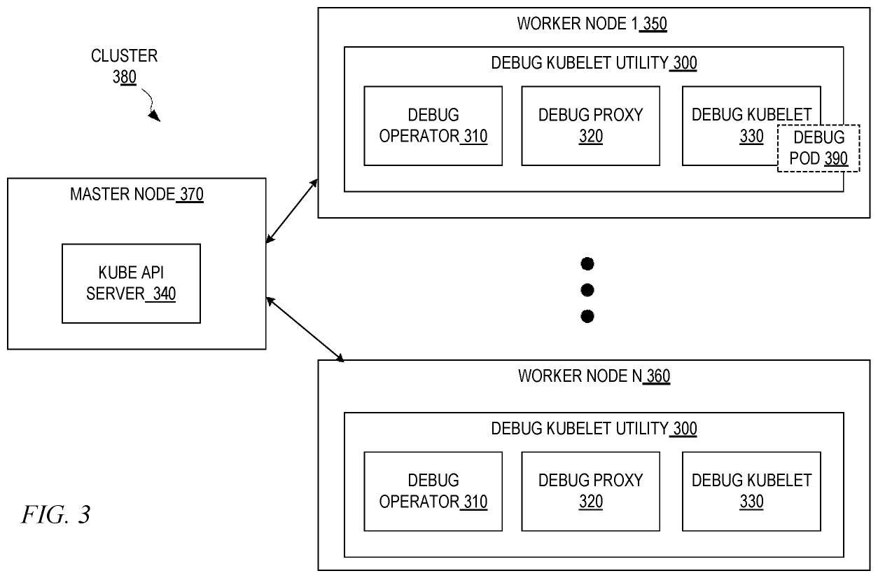

FIG. 3 is an example diagram illustrating the primary operational components of a debug kubelet utility in accordance with one illustrative embodiment. The operational components shown in FIG. 3 may be implemented as dedicated computer hardware components, computer software executing on computer hardware which is then configured to perform the specific computer operations attributed to that component, or any combination of dedicated computer hardware and computer software configured computer hardware. It should be appreciated that these operational components perform the attributed operations automatically, without human intervention, even though inputs may be provided by human beings and the resulting output may aid human beings. The invention is specifically directed to the automatically operating computer components directed to improving the way that failed worker nodes, or “broken nodes”, in a Kubernetes® cluster may be restored to a ready state, and providing a specific debug-kubelet utility that cannot be practically performed by human beings as a mental process and is not directed to organizing any human activity.

As shown in FIG. 3, the debug kubelet utility 300 comprises a debug operator 310, debug proxy 320, and debug kubelet 330. The debug kubelet utility 300 operates with a kube api-server 340 on a master node 370. The debug operator 310 and debug proxy 320 may be associated with a first worker node 350 and the debug kubelet 330 may be associated with a second worker node 360. The debug kubelet 330 is a debug node agent running on a worker node. While each worker node 350, 360 is configured with an instance of a debug kubelet utility 300 with a debug kubelet 330 to monitor the status of the worker node and determines when the worker node enters a critical/not ready state, when such a failure of the worker node occurs, the debug kubelet 330 of the failed/broken worker node communicates with the debug proxy and debut operator 310, 320 of another worker node in the cluster 380 that is in a ready state.

As shown in FIG. 3, the master node 370 controls the Kubernetes® cluster and is a node where all the control plane components are hosted. The Kube API server 340 is a control plane component in Kubernetes® which exposes endpoints where the clients, like kubectl, can communicate when creating or managing resources. The worker nodes 350, 360, etc. are nodes where a user's containerized applications are deployed. The debug kubelet utility 300 is a collection of components, e.g., debug operator 310, debug proxy 320, and debug kubelet 330, which work together to achieve the debugging of a failed worker node. Any script automation may be used, after a Kubernetes® cluster is created and ready for user application deployment, in order to deploy the components of the debug kubelet utility 300.

With regard to debug kubelet utility 300 installation, the debut kubelet utility 300 component installation may, in some illustrative embodiments, follow the following process. First, a NodePort service is created and the port number is updated in the debug kubelet 330 configuration file. This port is used by the debug kubelet 330 to communicate with the debug proxy 320. A server certificate is generated for the debug proxy 320 and a secret is created in Kubernetes® where these details are saved. Daemonsets (which ensures that all nodes run a copy of a pod) is then used to install the debug-kubelet in all worker nodes 350, 360, etc.

The debug operator 310 is implemented using a Kubernetes® operator pattern that is used to manage a Custom Resource (CR). A Custom Resource Definition (CRD) is created with CR name provided for the Kind parameter, and under the spec section, the CRD includes the workerName and bootstrapKubeConfig parameters. The workerName is the name of the critical (failed) worker. The bootstrapKubeConfig parameter is a bootstrap kubeconfig that is required to bootstrap the debug worker node in Kubernetes. The debug operator 310 is deployed as part of the debug kubelet utility 300 and is able to run on any available healthy nodes in the Kubernetes® cluster. Also, the CR for this component is cluster scoped and supports creation of multiple CRDs.

Upon CRD creation, the debug operator 310 creates/updates the Kubernetes® secret resource (a resource stored in a data store of the control plane and that holds sensitive information) with the workerName and bootstrapKubeConfig in key value pairs. The debug proxy 320 is created and deployed, and only one debug proxy 320 component needs to be running per Kubernetes® cluster. Upon CRD deletion, the workerName and bootstrapKubeConfig entries are deleted/removed from the Kubernetes® secret resource and the debug proxy 320 deployment is deleted if it is the last CRD.

A KubeConfig is a configuration file that contains groups of clusters, users, and contexts which the Kubernetes® mechanisms use to authenticate and interact with the clients. The bootstraphKubeConfig is also a KubeConfig file with a limited set of authorizations which the kubelet uses during the bootstrap initialization process to generate the System: Node CSR. The bootstrapKubeConfig file is created and bound to a system node-bootstrapper RBAC policy.

The debug proxy 320 acts a s proxy server which provides the bootstrapKubeConfig to the debug kubelet 330 when requested. The communication between the debug proxy 320 and the debug kubelet 330 are secured, such as by using SSL certificates or the like. That is, the debug kubelet 330 waits for a bootstrapKubeConfig Request from the debug kubelet 330 and upon receiving the request, determines if the worker name in the request is the same as the one created in the CRD. If there is a match, then the bootstrapKubeConfig is returned in a response. The debug proxy 320 is managed by the debug operator 310 and is only deployed after a CRD is created. The debug proxy 320 can be deployed on any available healthy (not critical/failed) worker nodes in the Kubernetes® cluster.

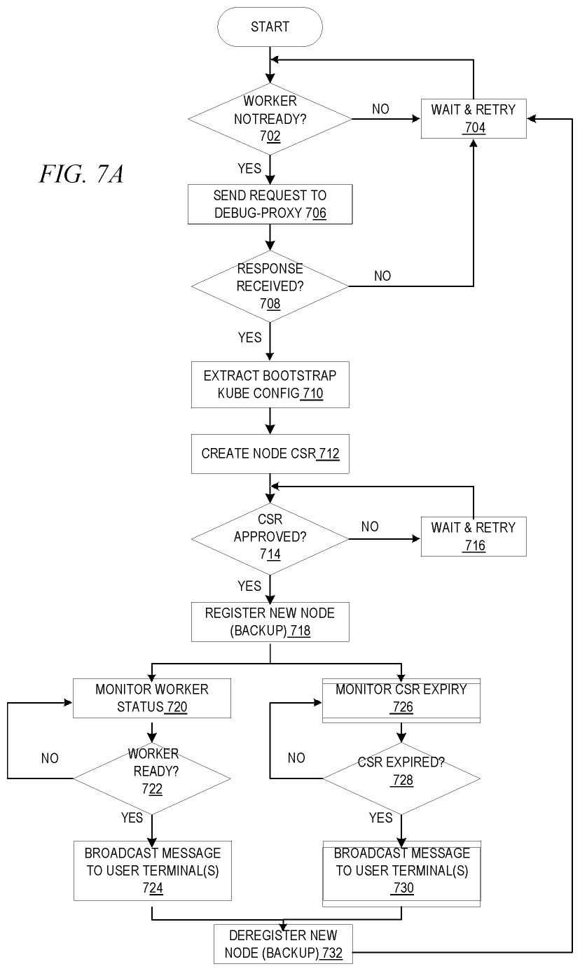

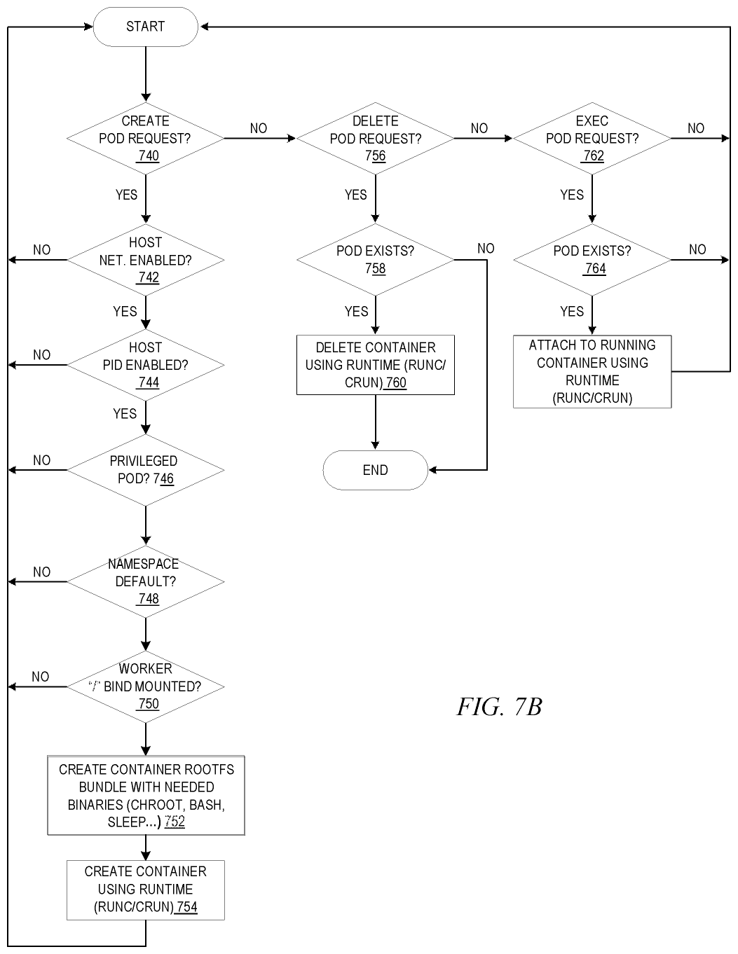

The debug kubelet 330 is a lightweight kubelet which hosts only the required functionalities to debug a critical (failed or not-ready) worker node in a Kubernetes® cluster. The debug kubelet 330 is installed as part of the debug kubelet utility 300 packages on all the worker nodes 350, 360, etc. which are healthy in the Kubernetes® cluster. The debug kubelet 330 is running all the time and performs the operations as set forth herein, e.g., see the outline of operations set forth in FIG. 7A, discussed hereafter.

The mechanisms of the illustrative embodiments bypass the dependency on the other failed components of the first worker node 350 by providing a debug kubelet utility 300 through which an authorized user, e.g., an administrator, may run commands to recover the first worker node 350, which is in a critical or not-ready state, under a cloud vendor SRE automated guidance. The debug kubelet 330 provides a mechanism through which a backup or debug worker node may be created and registered with the cluster with a minimum configuration to allow the user to run such commands and recover the first worker node 350 without having to have root file system access. The debug kubelet 330 is a lightweight kubelet that debugs critical/not-ready worker nodes, e.g., worker node 350, by reducing the multiple failure points in a standard kubelet flow. That is, the debug kubelet 330 operates to monitor the status of its worker node and determine if the worker node enters a critical or not-ready state.

The debug kubelet 330 works in conjunction with the debug operator 310 and debug proxy 320 of another worker node, e.g., worker node 360, in the cluster 380 that is in a ready state to create a debug or backup worker node and register it with the cluster. The debug or backup worker node, e.g., worker node 360, is then used to attach a debug pod to a running container of the backup or debug worker node which provides an interface and/or communication channel through which an authorized user can issue commands to debug the broken worker node and bring the broken worker nodes back to a ready state.

The debug kubelet 330 relies on the container runtime (crun/runc). With debug taints being set at the time of worker node registration with the Kubernetes® cluster, the debug kubelet 330 avoids regular workloads from being scheduled and deploys only one privileged debug pod. As the debug kubelet 330 does not have any image server, it locally creates a rootfs bundle with bare minimum binaries copied form the worker node to create contains using the container runtime (crun/runc). This allows an authorized user to effectively create a debug container in the worker without relying on any container image from external registries.

As mentioned above, the debug kubelet 330, which runs in client mode, monitors the worker node's current state using the preconfigured kubeconfig. When the state becomes critical or not ready, the debug kubelet 330 requests the debug-proxy 320 for a bootstrap kubeconfig. Once a response is received from the debug-proxy 320, the bootstrap kubeconfig is used to create a System: Node Certificate Signing Request (CSR) with a default expiry time, e.g., 2 hours or the like, and awaits authorized user approval. After the CSR is approved & issued by the authorized user, the debug kubelet 330 extracts the key & certificates from the CSR to register with the kube api-server 340 on the master node 370 and listens on a user-configured port. Now this newly registered backup, or debug, node is ready to deploy and exec into the debug pod 390. The debug pod 390 is scheduled on newly registered debug nodes when the original worker node enters a critical (failed) or not ready state. The debug pod 390 enables the execution of commands to troubleshot the critical worker node. Once the debug pod 390 is created successfully, an authorized user can login to the debug pod 390 using the kubectl exec command and open a bash terminal to run commands to fix the critical node. FIG. 7B, discussed hereafter, is an example flowchart explaining the debug pod lifecycle.

Meanwhile, debug kubelet 330, on the other hand, monitors the status of the current worker node, and when the state becomes ready, it will shut down the debug-kubelet 330. The debug-kubelet 330 will also be shut down when the System: Node CSR is expired.

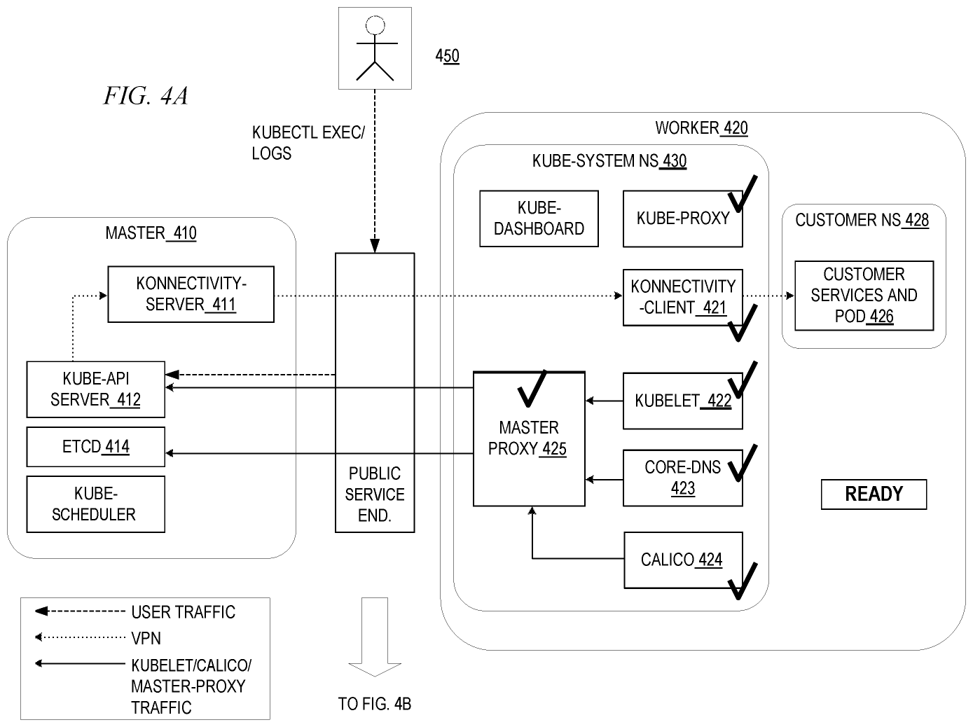

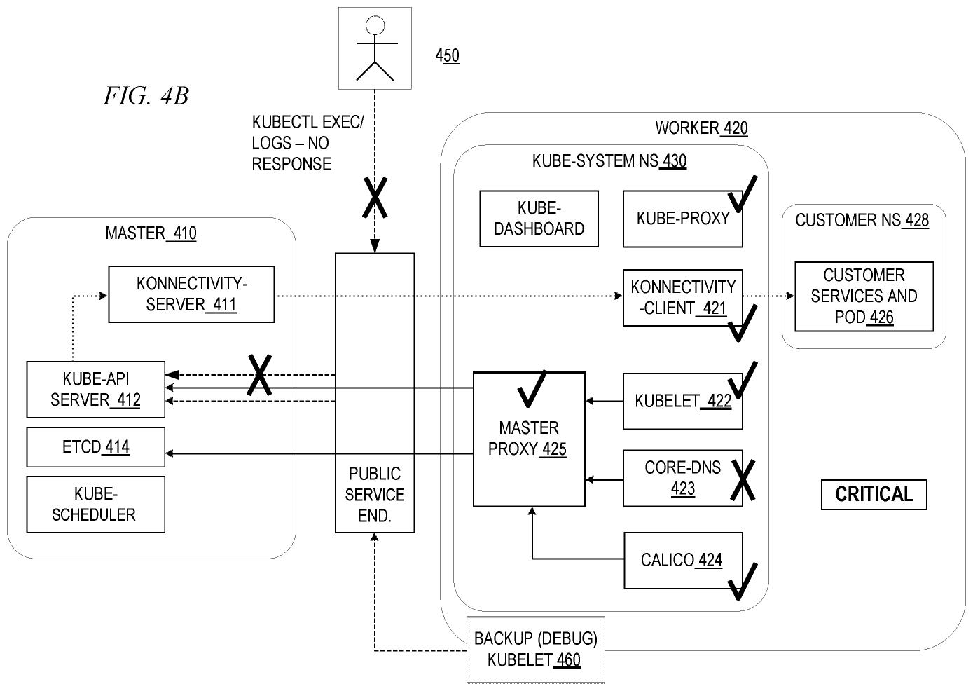

FIGS. 4A and 4B are example diagrams illustrating a worker node entering a critical/not ready state. FIG. 4A illustrates the operation of the worker nodes when the worker nodes are not in a critical or not ready state. FIG. 4B illustrates the communication flows when one of the worker nodes, e.g., worker node 420, goes into a critical or not ready state.

As shown in FIGS. 4A and 4B, in public cloud Kubernetes® as a service, master-worker communication channel between a Kubernetes® master node 410 and a worker node 420 is established using a VPN connection via konnectivity-server 411 and konnectivity-client 421. The other supporting components, such as kubelet 422, core-dns 423, calico 424, and master-proxy 425 are installed on the worker node 420 in the kube-system namespace (ns) 430. All these components should be up and running to make the worker node 420 ready to run a workload. While the worker node 420 is in a ready state, communications with the user, such as kubectl exec/logs are performed through the public service endpoint to the kube api-server 412. Kubelet, calico, and master-proxy traffic flows through the master proxy and the public service endpoint to the kube api-server 412 and etcd 414 (a key-value store). Traffic between the master node and the worker node occurs through the konnectivity-server 411 to the konnectivity client 421 to the customer services and pod in the customer namespace.

With reference now to the FIG. 4B, suppose any worker component, such as kubelet 422 (a primary node “agent” for the worker node), core-dns 423 (an extensible DNS server that can serve as the cluster DNS), calico 424 (a network connectivity plugin), master-proxy 425 (proxies are components that are intermediaries between components/users and the kube api-server), goes down, i.e., enters a critical/not ready state. The worker node 420 becomes unhealthy/critical/not ready, i.e., the worker node 420 is a broken node, which blocks scheduling any new pod or bringing down running pods, such as customer services and pod 426 in customer namespace 428 on that worker node 420. The worker node 420 will not respond to the user 450 submitted kubectl exec or kubectl logs commands, which in effect blocks the user 450 from debugging the issue.

The illustrative embodiments implement a debug kubelet 460 through a debug kubelet utility, such as 300 in FIG. 3, which runs with minimum dependency on the unhealthy worker node 420. The debug kubelet 460 is always running as a daemon process on all the nodes in the Kubernetes® cluster and monitors the state of its corresponding node, e.g., ready/not ready/critical. If any node goes into a critical state, for example, the debug kubelet 460 will register as a backup node in the node list.

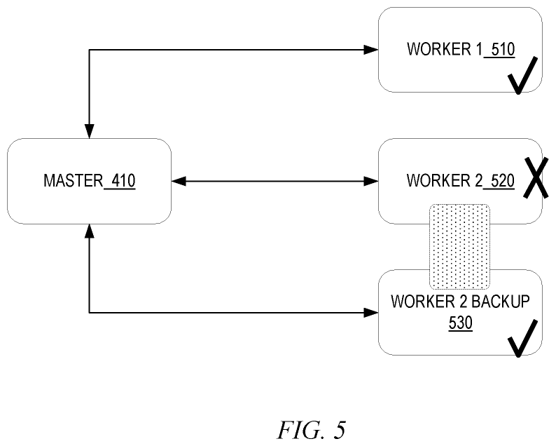

The debug kubelet 460 bypasses the need for other supporting components, e.g., core-dns 423, calico 424, and master-proxy 425, except for konnectivity-client 421. The debug kubelet 460 mimics the real kubelet 422 and gets registered as one more ready node to the master node 410 via the kube api-server 412. The user 450 sees this additional node of the debug kubelet 460, or debug node agent, as shown in FIG. 5.

As shown in FIG. 5, worker node 1 510 is healthy, and worker node 2 520 is unhealthy, i.e. broken. The worker node 2 backup 530 is the additional node registered on behalf of worker 2 520. The user can run a debug pod 532 on the worker 2 backup 530 and run kubectl exec commands to debug and fix the real worker node 520. The connection between the master node 410 and worker 2 backup 530, in some illustrative embodiments, is over a TCP SSL channel allowing the debug commands to run on the critical, or “broken”, node 420 or 520 securely.

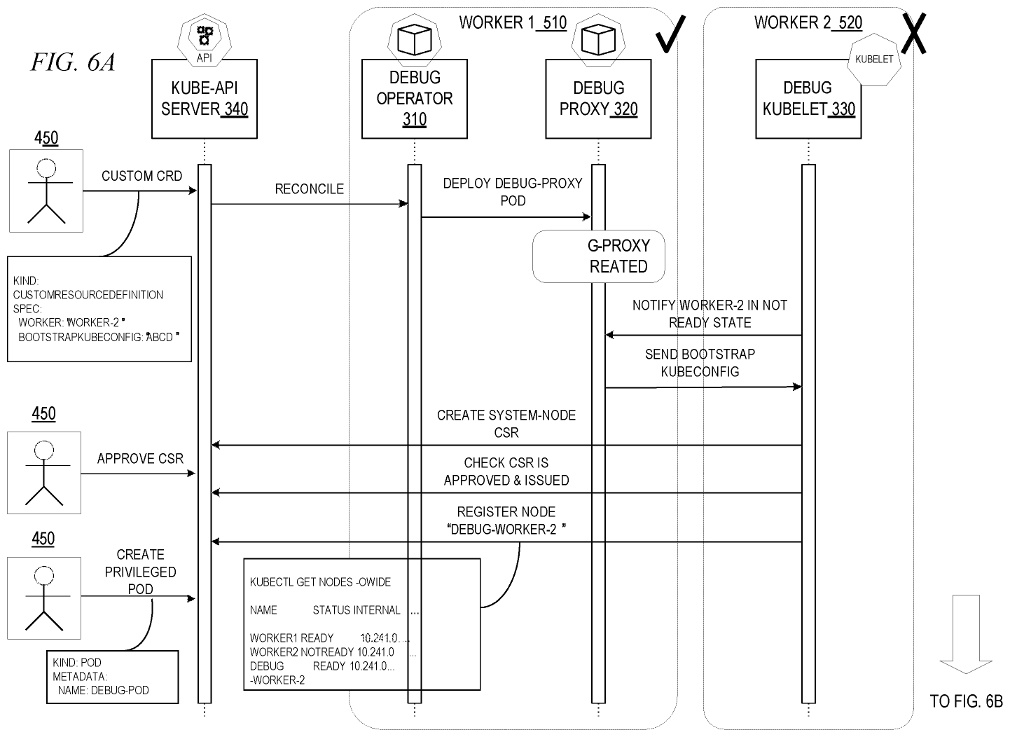

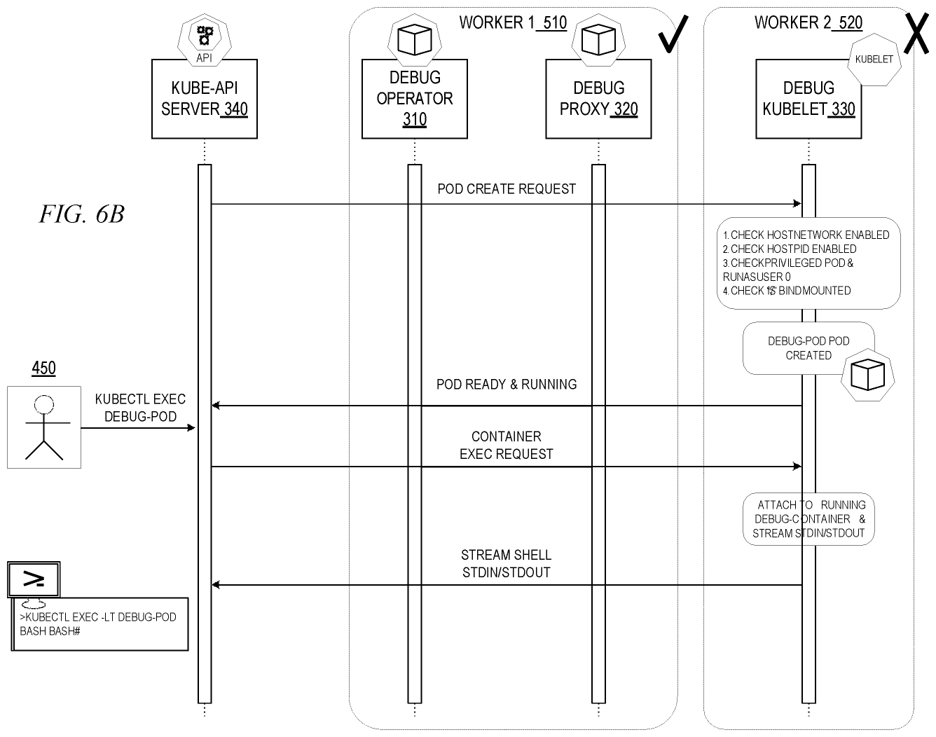

FIGS. 6A and 6B illustrate an example sequence diagram outlining how a Certificate Signing Request (CSR) and Pod create request are processed when a debug-kubelet is spawned in accordance with one illustrative embodiment. As shown in FIGS. 6A and 6B, when a worker node, e.g., worker 2, goes into a critical state, the user can create a Custom Resource Definition (CRD) that contains the worker name, e.g., “worker 2”, and the identification of the bootstrap kubeconfig file, which then deploys a debug-proxy 320 in any one of the available healthy worker nodes, e.g., worker 1. It is presumed that the debug-operator 310 is running in the Kubernetes® cluster, as it is deployed when the cluster is created, and the bootstrap kubeconfig and the respective role based access control (RBAC) rules are also created in the debug operator.

As shown in FIGS. 6A and 6B, after reconciling the customer CRD with the debug operator, the debug operator deploys the debug proxy pod resulting in the debug proxy pod being created. When the debug-kubelet 330 of a worker node, e.g., worker node 2, detects that the worker node is in a critical or not ready state, the debug kubelet 330 sends a notification/request to the debug-proxy 320. The notification/request notifies the debug proxy 320 that the worker node is in a critical/not ready state and, in response, based on the worker node details in the CRD, the debug-proxy 320 sends the bootstrap kubeconfig to the debug-kubelet 330. The debug kubelet 330 uses the bootstrap kubeconfig to create a System: Node Certificate Signing Request (CSR) having a default expiry time, e.g., 2 hours or the like.

The debug kubelet 330 checks whether the CSR is approved and issued or not. A user with admin privilege may approve the CSR externally and, in response, the debug-kubelet 330 uses that kubeconfig to register the backup or debug worker node, e.g., debug-workder-2, with the kube api-server of the master node in the cluster. Once the backup or debug worker node is successfully registered with the kube api-server and in ready state, the user can deploy a pod with hostNetwork, hostPID and privileged pod with “/” of the worker mounted to the container as bind mount, e.g., Create privileged pod, Pod Create Request in FIGS. 6A and 6B.

Based on the pod specification, debug-kubelet 330 uses the container runtime (crun/runc) to create the container, which allows users to exec into the running container to access the not-ready workers. That is the debug-kubelet 330 performs the checks of the pod and deploys the debug-pod pod with a notification to the kube api-server indicating the pod is ready and running. The user may then issue a kubectl exec debug-pod command to the kube api-server which sends a container exec request to the debug-kubelet 330. The debug-kubelet 330 attaches the debug-pod to the debug-container and allows user to open bash terminal for running troubleshooting command (e.g., stdin/stdout), The debug-kubelet 330 streams shell stdin/stdout to the kube api-server and the user is then able to log into the debug pod 390 in order to execute commands to fix the failed or critical worker node, e.g., by use of the command kubectl exec-lt debug-pod bash bash #.

FIGS. 7A and 7B are flowcharts of example operations performed by components of the illustrative embodiments. It should be appreciated that the operations outlined in FIG. 7A-7B are specifically performed automatically by an improved computer tool of the illustrative embodiments and are not intended to be, and cannot practically be, performed by human beings either as mental processes or by organizing human activity. To the contrary, while human beings may, in some cases, initiate the performance of the operations set forth in FIGS. 7A-7B, and may, in some cases, make use of the results generated as a consequence of the operations set forth in FIGS. 7A-7B, the operations in FIGS. 7A-7B themselves are specifically performed by the improved computing tool in an automated manner.

FIG. 7A is a flowchart outlining an example operation of a debug node agent, such as a debug kubelet for example, in accordance with one illustrative embodiment. As shown in FIG. 7A, the operation starts with the debug kubelet determining if the worker node is in a critical or not ready stated (step 702). In one illustrative embodiment, this involves the current worker node's status in the Kubernetes® cluster being monitored using the kubelet kubeconfig available at the default path, i.e., /etc/Kubernetes/. If the worker node is not in a critical or not ready state, the operation waits and retries (step 704). If the worker is in a not ready state, then a request is sent to the debug proxy exposed on the nodeport by providing the name of the worker node for which it expects a bootstrap kubeconfig in a response (step 706). A determination is made as to whether a response is received from the debug proxy (step 708). If a response is not received, the operation waits and retries (step 704). If a response is received, a bootstrap kube configuration is extracted (step 710). Bootstrapping a Kubernetes® cluster involves setting up the control plane and worker nodes and determining which node has the correct information with which all the other nodes should synchronize, i.e., which node is the master node. The bootstrap kube configuration file provides all the Kubernetes® cluster details, certificates, and tokens to authenticate the cluster. The kube configuration file is used by authorized users to connect to the Kubernetes® cluster API, or kube api server.

After extracting the bootstrap kube configuration file (step 710), a node Certificate Signing Request (CSR) is created, e.g., a System: Node CSR with a default expiry duration, e.g., 1 hour, is created (step 712). A determination is then made as to whether the CSR is approved by an authorized user (step 714). If not, the operation waits and retries (step 716). If the CSR is approved, the key and certificate details are extracted from the CSR and a new backup node is registered with the kube-api server (step 718).

The operation then branches to two substantially parallel operations. In a first branch of operation, the debug kubelet monitors the worker node status to determine if the worker node associated with the worker backup node has returned to a ready state (step 720). A determination is made as to whether the worker node is in a ready state (step 722). If not, the operation returns to step 720 and continues to monitor the worker node status. If the worker node is in a ready state, a message is broadcast to all logged in user terminals informing them of the ready state of the worker node (step 724). These are the users who opened the bash terminal to the debug pod using the kubectl exec command to troubleshoot the critical/not ready node. Multiple users can open a bash terminal to the same debug pod to perform troubleshooting in collaboration. The new (backup) node is then stopped and deregistered (step 732) and the operation returns to step 704 to wait and retry as needed.

In a second branch of operation, the debug kubelet monitors the CSR expiration (step 726). A determination is made as to whether the CSR has expired (step 728). If not, the operation returns to step 726 and continues to monitor the CSR expiration. If the CSR has expired, a message is broadcast to all logged in user terminals to inform them of the CSR expiration (step 728). The new (backup) node is then stopped and deregistered (step 732) and the operation returns to step 704 to wait and retry as needed.

FIG. 7B is a flowchart outlining an operation of a debug pod in accordance with one illustrative embodiment. The operation of FIG. 7B may occur, for example, after registering the new (backup) node in step 718 of FIG. 7A, for example. As shown in FIG. 7B, the debug pod of the debug kubelet handles the request sent to the debug proxy. The request may request creation, deletion, or execution of a pod. Thus, the debug pod first determines if the request requests the creation of a pod (step 740) and if so, the operation determines if a host network is enabled (step 742), whether the host PID is enabled (step 744), whether the pod being created is a privileged pod (step 746), whether the namespace is a default namespace (step 748), and if the worker “/” bind is mounted (step 750). If any of these checks indicate a “no” result, the operations returns to step 720, with the pod not being created. Assuming all of these checks pass, the container root file system (rootfs) bundle is created with the necessary binaries (step 752), and the container is created using the container runtime environment (runc/crun) (step 754).

Essentially, these steps wait for the privileged debug pod to be deployed by the user which must satisfy the following prerequisites: host network enabled, host PID enabled, must be a privileged pod, the namespace should be default, and the worker node's “/” root filesystem has to be bind mounted to “/host” of the container. On receiving the pod create request from the kube-api server, a rootfs bundle for the container is created with only required binaries like chroot, bash, and sleep, such as by copying the same from the current worker node. Once the rootfs bundle for the container is created, with the help of low level runtime applications like runc or crun, the container is created.

If the request is to delete a pod (step 756), a determination is first made as to whether the particular pod that is to be deleted actually exists (step 758). If not, the operate terminates without performing the delete operation. If the pod does exist, then the container is deleted using the runtime environment (runc/crun) (step 760).

If the request is to execute a pod (step 762), again a determination is made as to whether the pod exists (step 764). If not, the operation terminates and returns to step 740 without performing the pod execution. If the pod does exist, then the pod is attached to the running container using a low level runtime environment application (e.g., runc/crun) and stream the TTY terminal to the user which the user can use for debugging the current worker node (step 766).

The description of the present invention has been presented for purposes of illustration and description, and is not intended to be exhaustive or limited to the invention in the form disclosed. Many modifications and variations will be apparent to those of ordinary skill in the art without departing from the scope and spirit of the described embodiments. The embodiment was chosen and described in order to best explain the principles of the invention, the practical application, and to enable others of ordinary skill in the art to understand the invention for various embodiments with various modifications as are suited to the particular use contemplated. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method, in a data processing system, for recovering a worker node that is in a not ready state, the method comprising:
configuring a first worker node, in a plurality of worker nodes, of a cluster with a first debug utility that comprises a debug node agent that monitors an operating state of the first worker node;
monitoring the operating state of the first worker node to detect whether or not the first worker node enters a not ready state; and
in response to the debug node agent detecting that the first worker node enters the not ready state:
issuing, by the debug node agent, a request to a debug proxy of a second debug utility associated with a second worker node, in the plurality of worker nodes, that is in a ready state, to create a debug worker node for the first worker node;
obtaining, from a master node of the cluster, a custom resource definition (CRD);
creating the debug worker node in the cluster based on the CRD, wherein the debug worker node corresponds to the first worker node and comprises a minimum configuration for handling debug commands; and
processing debug commands from a user via the debug worker node to return the first worker node to a ready state.

2. The method of claim 1, wherein generating the debug worker node comprises invoking a debug node agent of the debug utility to create the debug worker node, and wherein the minimum configuration comprises at least a portion of binaries copied from the first worker node.

3. The method of claim 2, wherein the debug node agent provides a root file system bundle and deploys a privileged debug pod that provides a communication channel through which a user accesses the first worker node to issue the debug commands to return the worker node to the ready state.

4. The method of claim 1, wherein the debug worker node is generated without relying on a container image from an external container image registry.

5. The method of claim 1, wherein the CRD specifies a worker name of the first worker node and bootstrap kube configuration parameters required to bootstrap the debug worker node, and wherein a debug operator of the debug utility.

6. The method of claim 1, wherein creating the debug worker node in the cluster based on the CRD comprises deploying a debug pod to a running container of the debug worker node, wherein the debug pod provides an interface through which an authorized user is able to issue commands to the debug worker node to debug the first worker node.

7. The method of claim 1, wherein the debug node agent has a taint that prevents all workloads from being deployed other than a debug pod.

8. The method of claim 1, wherein the request is a request for a bootstrap kube configuration, and, in response to the debug proxy returning a response to the debug node agent:
creating a certificate signing request (CSR) with an expiration time;
awaiting a user approval of the CSR; and
in response to receiving a user approval of the CSR, extracting a key and certificate from the CSR to register with a kube api-server on the master node.

9. The method of claim 1, wherein the debug commands comprise a kubectl exec command and a command to open a bash terminal to run commands to bring the first worker node to the ready state.

10. The method of claim 1, wherein each worker node in the plurality of worker nodes of the cluster has a corresponding instance of the debug utility.

11. A computer program product comprising a computer readable storage medium having a computer readable program stored therein, wherein the computer readable program, when executed on a computing device, causes the computing device to:
configure a first worker node, in a plurality of worker nodes, of a cluster with a first debug utility that comprises a debug node agent that monitors an operating state of the first worker node;
monitor the operating state of the first worker node to detect whether or not the first worker node enters a not ready state; and
in response to the debug node agent detecting that the first worker node enters the not ready state:
issue, by the debug node agent, a request to a debug proxy of a second debug utility associated with a second worker node, in the plurality of worker nodes, that is in a ready state, to create a debug worker node for the first worker node;
obtain, from a master node of the cluster, a custom resource definition (CRD);
create the debug worker node in the cluster based on the CRD, wherein the debug worker node corresponds to the first worker node and comprises a minimum configuration for handling debug commands; and
process debug commands from a user via the debug worker node to return the first worker node to a ready state.

12. The computer program product of claim 11, wherein generating the debug worker node comprises invoking a debug node agent of the debug utility to create the debug worker node, and wherein the minimum configuration comprises at least a portion of binaries copied from the first worker node.

13. The computer program product of claim 12, wherein the debug node agent provides a root file system bundle and deploys a privileged debug pod that provides a communication channel through which a user accesses the first worker node to issue the debug commands to return the worker node to the ready state.

14. The computer program product of claim 11, wherein the debug worker node is generated without relying on a container image from an external container image registry.

15. The computer program product of claim 11, wherein the CRD specifies a worker name of the first worker node and bootstrap kube configuration parameters required to bootstrap the debug worker node, and wherein a debug operator of the debug utility.

16. The computer program product of claim 11, wherein creating the debug worker node in the cluster based on the CRD comprises deploying a debug pod to a running container of the debug worker node, wherein the debug pod provides an interface through which an authorized user is able to issue commands to the debug worker node to debug the first worker node.

17. The computer program product of claim 11, wherein the debug node agent has a taint that prevents all workloads from being deployed other than a debug pod.

18. The computer program product of claim 11, wherein the request is a request for a bootstrap kube configuration, and wherein the computer readable program further causes the computing device, in response to the debug proxy returning a response to the debug node agent, to:
create a certificate signing request (CSR) with an expiration time;
await a user approval of the CSR; and
in response to receiving a user approval of the CSR, extract a key and certificate from the CSR to register with a kube api-server on the master node.

19. The computer program product of claim 11, wherein the debug commands comprise a kubectl exec command and a command to open a bash terminal to run commands to bring the first worker node to the ready state.

20. An apparatus comprising:
at least one processor; and
at least one memory coupled to the at least one processor, wherein the at least one memory comprises instructions which, when executed by the at least one processor, cause the at least one processor to:
configure a first worker node, in a plurality of worker nodes, of a cluster with a first debug utility that comprises a debug node agent that monitors an operating state of the first worker node;
monitor the operating state of the first worker node to detect whether or not the first worker node enters a not ready state; and
in response to the debug node agent detecting that the first worker node enters the not ready state:
issue, by the debug node agent, a request to a debug proxy of a second debug utility associated with a second worker node, in the plurality of worker nodes, that is in a ready state, to create a debug worker node for the first worker node;
obtain, from a master node of the cluster, a custom resource definition (CRD);
create the debug worker node in the cluster based on the CRD, wherein the debug worker node corresponds to the first worker node and comprises a minimum configuration for handling debug commands; and
process debug commands from a user via the debug worker node to return the first worker node to a ready state.
